(19) United States
(12) Patent Application Publication
(10) Pub. No.: US 2007/0210524 A1
(43) Pub. Date: Sep. 13, 2007

(54) PISTON RINGS

(76) Inventor: Christian Herbst-Dederichs, Burscheid (DE)

Correspondence Address: Robert L Stearsn;Dickinson Wright, 38525 Woodward Avenue, Bloomfield Hills, MI, 48304-2970, US

(21) Appl. No.: 10/599,301

(22) PCT Filed: Jan. 29, 2005
(86) PCT No.: PCT/DE05/00138

§ 371 Date: Sep. 25, 2006

(30) Foreign Application Priority Data
Mar. 26, 2004 (DE) 10 2004 014 871.6

(51) Int. Cl. F02F 5/00

(52) U.S. Cl. 277/310

(57) ABSTRACT

The invention relates to a piston ring which has at least one bearing surface and an upper and a lower flank. The bearing surface is provided with a High Velocity Oxygen Fuel (HVOF) coating which has a surface roughness Rk<0.1 μm.

The invention concerns a piston ring comprised of at least one operating surface as well as an upper face and a lower face.

The JP-A 57046048 infers a rectangular piston ring, when viewed in cross-section, having a thermal sprayed layering on the basis of molybdenum. The faces of the piston ring are equipped with a protective layer of Chrome.

In DE-A 197 20 627 a layered piston ring with all related manufacturing procedures is described. Even where the upper surface rating of the operating surface may be considered to be sufficient for the occasional use, the piston rings described in the aforementioned publication are not functionally appropriate for use in highly demanding motors. This is in reference to the fact that the piston ring faces are subjected to very high wear, and therefore provide a lesser durability.

Even where the JP-A 57046048 already offers a chromed face area with a rectangular ring, this problem cannot simply be put off onto trapezoidal formed faces in connection with operating surfaces having a sprayed layering. This is essentially based on the penetration of the acidic Chrome electrolyte into the layering of the operating surface, resulting in the possibility of damage or dissolving of the operating surface layering. In this respect additional research is needed.

The invention is based on the task of forming a piston ring in further development so that the piston ring can be used even in highly demanding motors with high reliability demands. This should especially be possible for those piston rings which, in the area of at least one face, are at least partially trapezoidal in form. Beyond this a manufacturing procedure for the production of this type of piston ring should be made available, with which this type of piston ring can be produced in a simple form and in a cost-effective manner.

This task is solved by a piston ring containing at least one operating surface as well as an upper face and a lower face, where the operating surface includes a layering applied in accordance with the so-called High-Velocity-Oxy-Fuel (HVOF) procedures, and having a surface roughness factor Rk<0.12 μm.

Advantageous further developments of the piston ring as presented in this invention may be gathered from the representational sub-claims provided. The piston ring can hereby represent a rectangular cross-section as a standard configuration, where variations may also occur, such as where the trapezoidal forming of the face area may be possible.

A procedure to produce a piston ring of this type is thereby characterized that multiple piston rings may be associated in packets, with the operating surfaces of the piston ring blanks provided with a thermal sprayed layering in accordance with the HVOF-procedures, the piston rings individually and in the area of at least one of their faces, temporarily subjected to a trapezoidal processing, and subsequently at least the trapezoidal formed face area having a galvanized isolated protection layer applied.

Advantageous further developments of the piston ring as presented in this invention may be gathered from the representational sub-claims provided.

The operating surfaces of the piston rings may temporarily be equipped with a chamber or may be formed with an oversprayed ring profile in a cylindrical surface area form.

By adjusting the very low porosity from an advantageous <5%, especially <3%, the penetration of the galvanic electrolytes into the surface area layer can most surely be avoided, so that the HVOF-procedures in the surface area layering of the piston rings as per this invention may be used with confidence. Also the very low upper surface roughness of Rk<0.12 μm hinders electrolytes being retained in the upper surface capillaries of the operating surface layer and causing an upper surface damage of the operating surface layering.

Especially long lasting operating surface layering can be achieved in connection with the aforementioned low values in porosity and upper surface roughness through the applied HVOF-procedures of WC, TiC, CrC or similar carbide work materials.

A subsequent processing of the piston ring face is not required as a rule. That is, the chrome face no longer requires the expensive post-production work. The piston ring can be made from steel or may be cast as needed, where the chrome layer strength is envisioned to be of the same thickness on the faces, and certainly in a chrome face strength between 1 μm and 20 μm, especially between 5 and 10 μm.

The subject of this invention is presented on the basis of the execution examples in the drawing, and is described as follows. They depict:

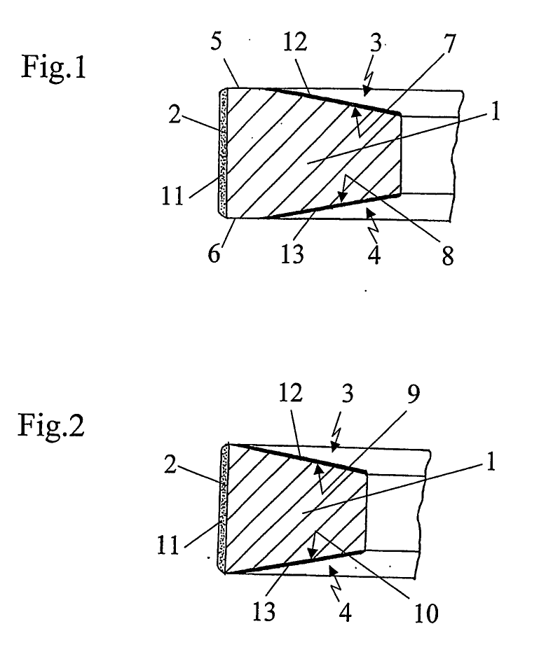

FIGS. 1 through 3 Varying execution forms of surface area layered trapezoidal piston rings

FIG. 4 operating surface layered piston ring in cross-section

The piston rings represented in FIGS. 1 through 3 each contain an operating surface 2 and a face area 3, 4, where the face area 3, 4 may be formed differently.

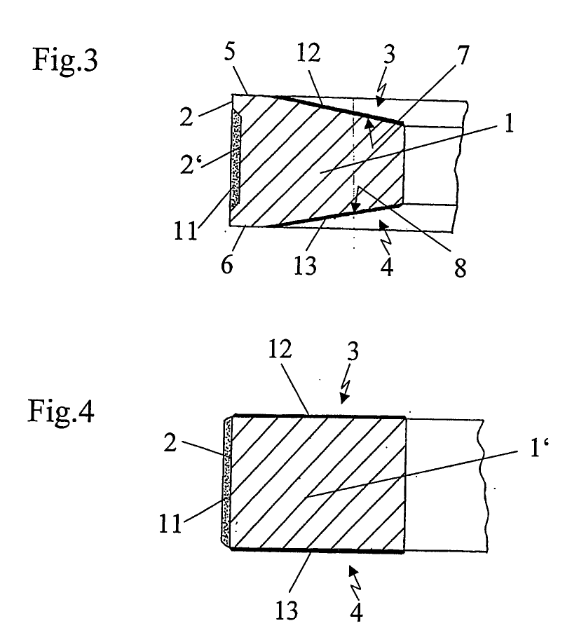

FIGS. 1 and 3 contain face-side areas 5, 6 initially parallel to each other, and then presented transitioning into trapezoidal form areas 7, 8.

FIG. 2 shows the trapezoidal form areas 9, 10, which are immediately adjacent to operating surface 2.

While the piston ring 1 according to FIGS. 1 and 3 is in analog form, as described in the DE-A 197 20 627 documentation, and as held can receive the thermal spray layer 11 according to the HVOF-procedures, for example, on the basis of WC, TiC or CrC, the piston ring 1 in accordance with FIG. 2 may also be formed as a rectangle and covered with a thermal spray layer 11. After the successful layering, the trapezoidal reworking must then be accomplished.

At least the trapezoidal formed areas 7, 8, 9, 10 will have a comparably thick galvanic isolated chrome layer 12, 13 after successful application of the HVOF-operating surface layering 11, where the chrome layer thickness in this example should be 5 μm.

Where FIGS. 1 through 3 show cylindrical operating surfaces 2, FIG. 3 also depicts a chamber 2′ in the operating surfaces 2 that is filled with the thermal spray layer.

In all examples the thermally sprayed operating surface areas 11, with porosity of 3% and an upper surface roughness of RK<0.10 μm as measured in an axial direction, are formed so that the penetration of the galvanic electrolytes in the isolation of the chrome layer 12, 13 onto the face areas 3, 4 into the thermally sprayed layers 11 are avoided in all cases.

FIG. 4 shows a piston ring 1′ in analog perspective as described in FIGS. 1 and 3, having an operating surface 2 as well as an upper face area and a lower face area 3, 4. The operating surface 2 is layered with a thermal spray layer 11 in accordance with the HVOF-procedures, for example, on the basis of TiC layering. The piston ring 1′ has a rectangular cross-section. The face areas 3, 4 exhibit a galvanic isolated chrome layer 12, 13.

1-12. (canceled)

13. A piston ring having at lest one operating surface, an upper face and a lower face, where the operating surface includes an HVOF-applied layering having a surface roughness factor Rk<0.12 μm.

14. The piston ring according to claim 13 wherein the layering has a surface roughness factor of Rk<0.10 μm.

15. The piston ring according to claim 13 wherein the layering has a surface roughness factor Rk<0.08 μm.

16. The piston ring according to claim 13 wherein the layering comprises carbide materials.

17. The piston ring according to claim 13, wherein the layering is made of carbide materials selected from the group consisting of WC and/or TiC, and/or CrC.

18. The piston ring according to claim 13 wherein the layering has a porosity of <5%.

19. The piston ring according to claim 13 wherein at least one of the upper and lower faces is at least partially trapezoidal in form.

20. The piston ring according to claim 19 wherein the at least one trapezoidal formed face area is provided with a galvanic protective layer.

21. The piston ring according to claim 20 wherein the galvanic protective layer is chrome-based material.

22. The piston ring according to claim 21 wherein the galvanic layer has a thickness between 1 μm and 20 μm.

23. A method of making piston rings, including gathering a plurality of piston rings in a packet of such rings, exposing operating surfaces of the packet of rings to a HVOF process whereby a layering of thermal sprayed material is applied to the operating surfaces; forming at least part of an upper and lower surfaces of the individual rings into a trapezoidal shape and applying a galvanic layer over the trapezoidal areas.

24. The method of claim 23 wherein when applying the layering a porosity <5% and an upper surface roughness measured in an axial direction of Rk<0.10 μm in the layering is obtained.

25. The method of claim 23 wherein the galvanized layer has a thickness between 1 and 20 μm.
